(19) United States
(12) Patent Application Publication
(10) Pub. No.: US 2008/0084305 A1
(43) Pub. Date: Apr. 10, 2008

(54) RF TAG SECURITY AND REPORTING SYSTEM

(76) Inventor: Vaughn R. Arnold, West Palm Beach, FL (US)

Correspondence Address: MCHALE & SLAVIN, P.A., 2855 PGA BLVD, PALM BEACH GARDENS, FL, 33410, US

(21) Appl. No.: 11/467,821

(22) Filed: Oct. 10, 2006

(51) Int. Cl. G08B 13/14; G08B 1/08; G08G 1/123; B60R 25/10

(52) U.S. Cl. 340/572.1; 340/988; 340/539.13; 340/426.1

(57) ABSTRACT

An integrated security system having an activator interfaced with a geographical locator component based on RADAR, GPS, LORAN or other satellite communications systems to establish the location of an item to be monitored. An RF tag sub-system permits the security system to perform an inventory function of the item to be monitored The system includes a control unit having a computer with a CPU and memory to receive and store the geographical coordinates of the established location. A communications component of the system sends a signal to proper authorities when the stored geographical coordinates change.

### FIELD OF THE INVENTION

This invention relates to the field of security equipment and in particular to use of a RF tag security system for use tracking, monitoring and reporting of items moved from a fixed geographical position.

### BACKGROUND OF THE INVENTION

Systems for monitoring and reporting of the items that can be moved is well known. The instant inventor having obtained U.S. Pat. No. 6,567,790 for a monitoring and reporting system used in the detecting of conveyance movement. While such conveyances are typically thought of as vehicle and/or airplane movement, there remains a great need to for monitoring and tracking of items associated with the conveyance. For instance, a trash dumpster delivering vehicle, delivering dumpsters to contracting customers at their desired locations consists of the vehicle and the dumpster. When a dumpster is dropped off the truck, their exists a need to track the dumpster now separated from the vehicle.

Another example is a vehicle and its operator. When an operator is separated from the vehicle, a means for tracking the individual can be converted to disabling of the vehicle when the operator is not within a predetermined range.

Still another example is the need for tracking of troops that are in constrained and/or harsh environments. In this example the troops may be tracked by a vehicle within a proximity and the vehicle operates as the transfer mechanism to a remote command post.

U.S. Pat. No. 6,587,790, the contents of which is incorporated herein by reference, is directed to a security system for vehicles. The security system includes a module placed on the vehicle which is interfaced with a geographical locator component based on GPS or the like satellite communications systems and may include RADAR and/or LORAN to further establish the location of the vehicle when concealed from satellite view. In operation, the system includes a STAY function that is self monitoring and will signal proper authorities should the vehicle be moved from its authorized position.

U.S. Pat. No. 6,092,000, issued to Batteman, is directed toward substituting ground based recording and storage of in-flight data for the “black boxes” carried by commercial airlines. The system includes an alert signal generating phase activated when the operational data is outside normal limits. The system uses GPS (Global Positioning System) or other locating devices for geographical location of the aircraft. The communications may be satellite, telemetry or cellular systems. The in-flight data is transmitted to a ground based receiver and storage facility.

U.S. Pat. No. 5,933,098, issued to Haxton, discloses an aircraft security system using an aircraft mounted sending unit that sends a timed signal to a central computer once the system is armed. A central computer monitors the various aircraft at a facility. Appropriate alarms are generated, if the signal is not received according to schedule. The system may also include intrusion alarms on the aircraft to indicate tampering. A tracking function uses GPS data to locate an aircraft and transmit the location to the central computer when the aircraft is within the bounds of the network.

U.S. Pat. No. 5,918,183, issued to Janket et al., discloses a mobile transceiver for broadcasting and receiving a radio signal in the cellular telephone band coupled with a GPS for generating a geographical fix. The device is concealed on a vehicle and can signal the police with a fix. The system is activated by an engine start, auto alarm or abnotmal engine start.

U.S. Pat. No. 5,796,178, issued to Onuma, discloses a vehicle mounted system that memorizes or stores the position of engine stop and compares that position with position of attempted engine start. The system blocks engine start if the positions do not match within a predetermined range.

U.S. Pat. No. 5,751,246, issued to Hertel, teaches a system for establishing an electronic geographic perimeter for items equipped with a mobile GPS unit. The permitted geographic perimeter must be loaded into the database by keyboard or other conventional methods. The GPS unit continuously sends a signal to the control unit The control unit sends an alarm when the GPS unit crosses the perimeter boundary. The system can also be used to locate particular items within the perimeter boundary.

What is needed system for collecting of certain data from ancillary items otherwise secured to a conveyance that has a fixed geographical position, said system further electronically establishing a geographical position of the ancillary item in its last authorized position and automatically notifies the proper authorities upon the unauthorized movement of that item.

### SUMMARY OF THE INVENTION

A security system for determining movement of an object, such as a automobile, container, or even a human wherein an activator is interfaced with a geographical locator component based on RADAR, GPS, LORAN or other communications systems to establish the location of the item to be secured. The system includes a control unit having a computer with a CPU and memory to receive and store the geographical coordinates of the established location. A communications component of the system sends a signal to proper authorities when the stored geographical coordinated change.

Accordingly, it is an objective of the instant invention to teach a security system which generates a signal including the geographical coordinates of a reference location and generates an alert signal when the object or item is moved from the reference location.

It is a further objective of the instant invention to teach an security system that has multiple modes to provide for authorized movement of the object or item that is secured without generating an alert.

It is another objective of the instant invention to teach a security system that provides geographical coordinates, speed, direction, and elevation during authorized or non-authorized movement upon being electronically interrogated, wherein the data may be superposed on a map.

It is a further objective of the instant invention to teach that a security system continues to signal the geographical location coordinates after generating the alert.

Still another objective of the invention is to allow a government agency to use a vehicle reporting system located in agency vehicles, to communicate with the base command and control website to determine the location of the vehicle having an emergency.

Still another objective of this invention is to provide a security system that during programmed periods or periods of inactivity, the system will go into a sleep mode where it is still able to respond to outside stimuli. The stimuli can be either a signal from an inertial sensor sensing motion, or a signal received commanding it to wake and report status and receive program updates. At no time is the system completely uncontrollable or insensitive to stimuli.

Still another objective of the invention is to transmit an ALERT when activated by a Panic Button on an RF remote, the system will transmit an ALERT to the Customer/Commander (CC) signaling an observed emergency external perceived by the operator.

Yet still another objective is to provide an ALERT to be sent to a Customer/Commander when the system is placed in a STAY mode and a vibration or shock is sensed.

It is yet another objective of the instant invention to teach a security system that can be used by self powered, but not necessarily moved by vehicles, to allow tracking thereof. Such an example would be the tracking of troops by a command center providing instant troop position location.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a representation of the integrated security system of this invention;

FIG. 2 is a diagram of the handheld RF remote controller;

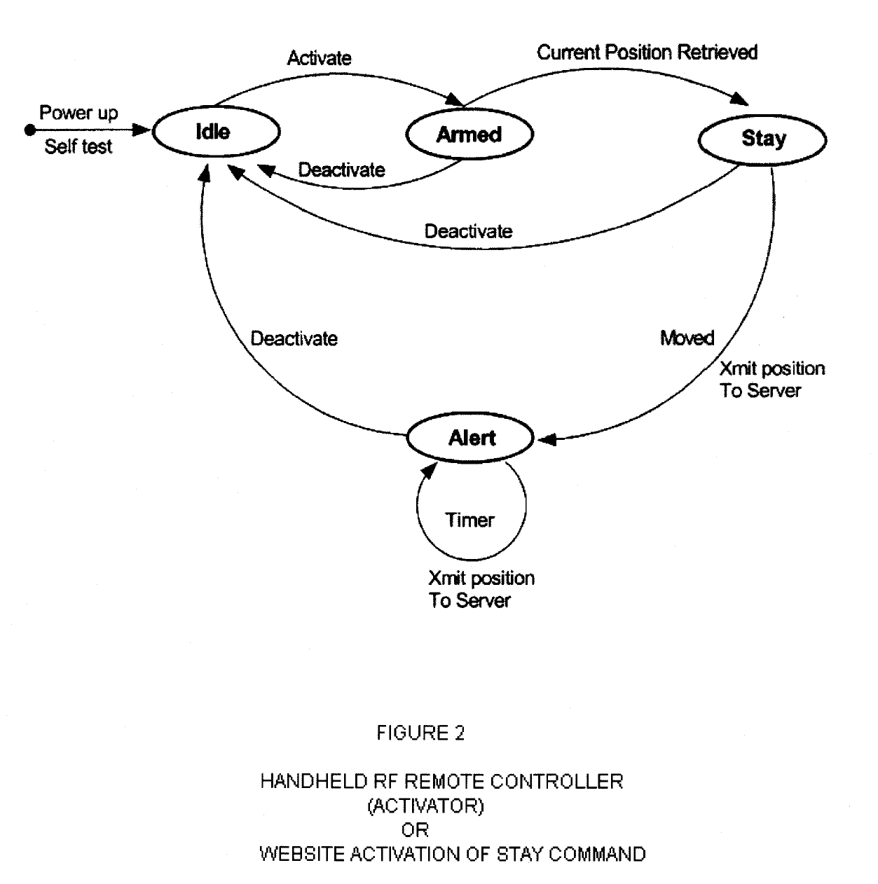

FIG. 3 is a block diagram of the vehicle RF receivers both inside and outside of a vehicle.

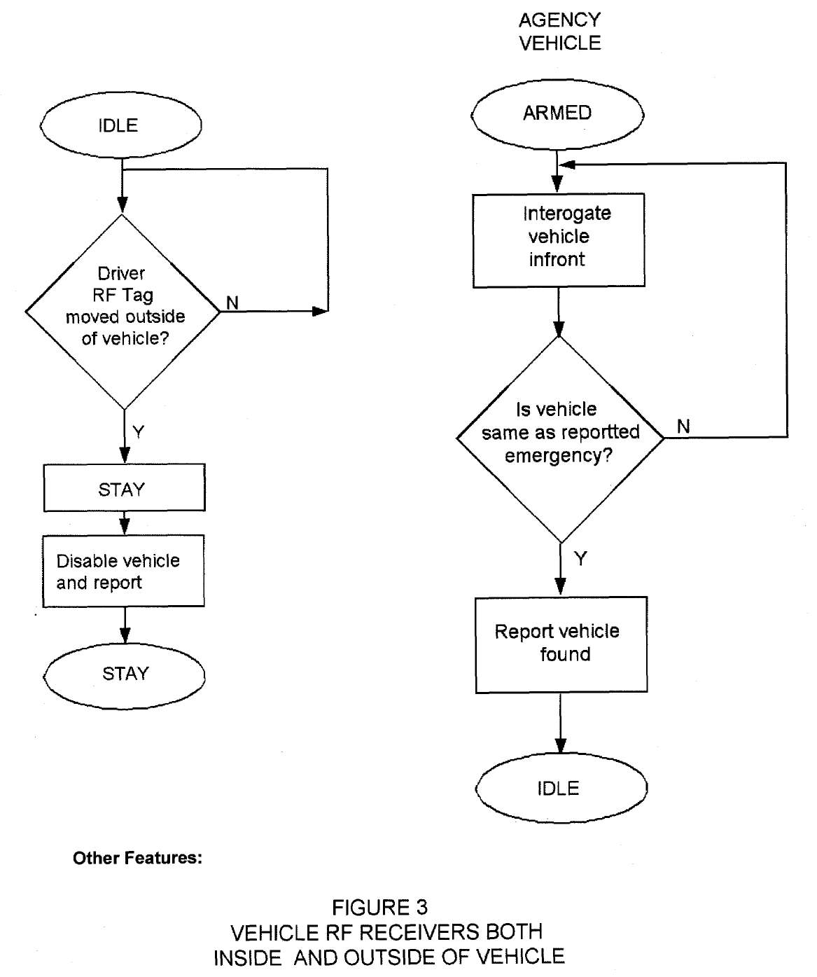

### DETAILED DESCRIPTION OF THE INVENTION

GPS is an acronym for a conventional global positioning system based on triangulation between multiple satellites to locate a mobile unit anywhere in the world. GPS will replace most other ground based navigation systems, such as LORAN which is a system of long range radio stations and short range, VOR, aviation net. Initially, the GPS units were being placed in airplanes, boats and road vehicles but the new uses of the system continue to expand, such as inventory control and marketing.

The security system 10 of this invention makes use of GPS as the primary tracking mechanism. By way of example, a trash dumpster is delivering by a carrier to a contracting customer at a desired location. The dumpster is then left in that location until the contracting customer informs when the dumpster is ready to be removed. The time period could be days or months. By use of the instant invention, when a dumpster is dropped off, an RF Tag inventory system component of the instant invention records the serial number of the dumpster, the time of delivery, the vehicle number used for delivery and the operator's name performing the delivery. This data can be stored in a database or programmed to be transmitted by way of commercial GSM, GPRS phone systems or radio systems, to the delivery company's base website.

The Position of the drop off can be determined by the GEO Position function and designating a “STAY” for the particular piece of equipment or by using any other GPS system interfaced to the Equipment Security and Reporting System. The next time the vehicle returns to the particular location and the inventory does not register the dumpster, then an alert will be registered as lost inventory. This alert can either be transmitted to the customer or retained in the inventory database for download at the conclusion of the work day. The RF Tag sub-systems is based on Alien RFID equipment or their equivalent. This system reports the equipment, inventory, and security status. The versatility of this invention is not limited to dumpsters but rather uses the dumpsters to illustrate the most basic non-powered items that can be stationary or moved. A most mobile unit is the automobile, which is illustrated hereinafter as it has self contained ability to be moved under its own power. For this reason, automobiles are prone to misuse and theft. This device can further be used to track individuals including battalions of solders allowing command centers to instantly known the position of troops on the ground and track movement as necessary.

Position of any item or vehicle using this system, is determined by the best means available according to the Navigation Protocol described later in this document. The position is called a Geo Position and is a Best Known Position (BKP) within the accuracy of the type of system used. A calculated Circular Error of Probability (CEP) is determined for each system or combination of systems used.

The STAY command used by this system is based upon the teachings set forth in U.S. Pat. No. 6,567,790 which is incorporated herein by reference. The STAY command reflects an instruction whereby an item, such as a vehicle, is commanded to remain in one location and if the status changes as to power activation of systems programmed to be inactive, or motion is sensed when it is not to be moving, or the planned path in memory is no longer being followed, an Alert is sent to the exterior commander to implement any appropriate security action. When the unit is stationary, the position is referred to as a Geo Position within the known accuracy of the measuring system. When the vehicle is moving along a planned and authorized path comprising of multiple Geo Positions.

A Handheld Remote Control is used to activate the STAY command or activate a Panic Button to send an alarm to the central command base website for appropriate programmed actions.

The vehicle, item 1, reporting system also monitors RF Tags in and around the vehicle to control equipment and determine the whereabouts of personnel critical to the operation of the vehicle. If either a piece of equipment, package or person has an RF Tag sub-system, such as sold by Alien RFID equipment or their equivalent, item 6, the system will know when the tag, and that which it is attached, is removed from the vehicle. If programmed, a report will be sent to the base command control website stating the absence of the labeled person, package or equipment. If also programmed, the vehicle systems can be disabled to disallow any operation unless the proper RF Tag, item 6, is back within the vehicle, item 1.

An agency vehicle, item 2, once driving up behind a vehicle having the perceived emergency, item 7, can interrogate the vehicle and determine the actual identity by using an RF Tag sensor on an agency vehicle. The RF Tag can either be located on a vehicle feature or the actual license registration sticker on the rear of item 7.

For the agency vehicle, the Vehicle Reporting System can be programmed for special agency functions such as if the RF Tag on the agency officer's uniform remains stationary outside the vehicle but within the bounds of sensing for more than 5 minutes, then a signal is transmitted to the base command website and an appropriate alarm can be initiated. All variations can be programmed to meet specific customer requirements.

Monitoring and reporting systems which can be carry-on or installed into a vehicle. The system determines the STATUS of the vehicle and its equipment, then reports to the Commander/Customer (CC) via any communication system currently available to the system. If only a GSM phone is available, the communication protocol software will determine all other systems are either inoperative or not available and then places the STATUS call via GSM. If a Emergency Location Transmitter (ELT) with 406 MHz capability becomes available during times when GSM signal is no longer reliable, the STATUS will be reported by 406 MHz to the COSPAS-SARSAT in geo-sync orbit and the emergency relayed to the CC. The CC through any communication link, has programmability options to a.) change the reporting intervals, b.) change Communication Protocols, and c.) change STATUS/ALERT protocols.

Depending on the number of available or partially available communication sub-systems, the programmed Communications Protocol will choose the highest relative rated sub-system or part of multiple sub-systems in order to fully communicate with the CC. For example if the GSM phone system is not transmitting fully with the CC, but it is receiving clearly, then the outgoing message will be delivered by 406 MHz ELT. Other “Multiple Levels of Communication” (MLC) can be enacted for example using an aircraft transponder, VHF and HF radios, VOR and ADF receivers, SATCOM telephone, (2) way or Internet messaging. Examples of this Communication Protocol logic are:

| | |
|---|---|
| UES=1 | “stay with unauthorized entry/ |
| engine start” | |
| STATUS=1 | “status changed” |
| ALERT=1 | “alert generated from cpu” |

```
ALERT IF(ALERT=0) Go To STATUS “recheck status sub-routine
and report”
  IF(STATUS=0) Go To STATUS “recheck status and
report”
  IF(UES >0) Go To COMM CC
  IF(UES=0) Go To STATUS “return to status sub-
routine”
```

| | |
|---|---|
| COMM CC TEST COM EQUIP | “test all available comm |
| resources and report” | |
| COMM=6 | “gsm phone operable” |

IF(COMM=6) Go To TRANS6 (UES) “trans using Motorola gsm
phone”
IF(COMM=5) Go To TRANS5 (UES) “trans using Motorola-sat
phone”
IF(COMM=4) Go To TRANS5 (UES) “transmits using vhf or hf
radios”
IF(COMM=3) Go To TRANS5 (UES) “transmits using RESCU406AF
elt”
IF(COMM=2) Go To TRANS5 (UES) “transmits using transponder”
TRANS5 (UES) “transmit/receive sub-routine”
IF(UES=1) TRANS6=1 “transmitting/receiving on gsm phone”

| | |
|---|---|
| IF(UES=0) GO TO STATUS | “return to status sub-routine” |
| IF(REC=0) GO TO COMM CC | “return to comm cc for retest” |

Sensors determining the vehicle and vehicle's equipment STATUS are; oil pressure, battery voltage, temperature, RF tag inventory, vibration and shock, panic button, and sonic, or whatever sensors are employed to determine the STATUS. If any STATUS changes while in the STAY operation, a STATUS alert is generated and report is sent to the CC. This includes but not limited to sensors or other security components interfaced to the overall system but may be inside or outside the vehicle, providing area and equipment security and reporting to the system by wire or wireless signals or networks. For example, a motion sensor could be in operation performing outside security functions, and when it is tripped, a programmed response is achievable from the Vehicle Reporting System according to the Communication Protocol. Examples of typical Sensor input alert logic is:

```
  RF=1
IF(RF>0) Go To ALERT  “STAY with unauthorized RF Tag change”
IF(RF=0) Go To STATUS  “return to status sub-routine”
ALERT IF(ALERT=0) Go To STATUS “recheck status sub-routine
  and report”
ALERT=1
IF(STATUS=0) Go To STATUS  “recheck status and report”
Code RF=1  “STAY with unauthorized RF Tag change”
IF(RF >0) Go To COMM CC
IF(RF=0) Go To STATUS  “return to status sub-routine”
```

Another example of Sensor input alert logic:

| | |
|---|---|
| UES=1 | “STAY with unauthorized entry/engine start” |
| STATUS=1 | “status changed” |
| ALERT=1 | “alert generated from status sub-routine” |

| ALERT IF(ALERT=0) Go To STATUS “recheck status sub- | | |
|---|---|---|
| routine and report” | | |
| IF(STATUS=0) | Go To STATUS | “recheck status and report” |
| IF(UES >0) | Go To COMM CC | |
| IF(UES=0) | Go To STATUS | “return to status subroutine” |

Vehicle position is determined by the available navigation sub-systems interfaced to the Vehicle Reporting system. Alternatively, all system navigation inputs are from stand-alone NAV systems, not interacting with the vehicle's own systems. These NAV system receivers are any or all of; GPS, Inertial Nav, LORAN, Inertial Navigation System (INS), VOR and ADF. As with MLC, a best known position (BKP) is determined using a programmed Navigation Protocol. Multiple Nav inputs are polled from the available Nav sub-systems and compared against each other to determine the BKP with a Circular Error of Probability (CEP). This BKP/CEP is compared to the last GEO Position and if in the STAY mode, the system will generate an ALERT if the vehicle has deviated from its STAY position or if moving, from its programmed authorized path or Geo Rail.

Examples of the Navigation Protocol logic are:

```
  BKP=(1001011,1010101) “digital representation of
lat/long”
AIR/GEO  “nav sub-routine to update position”
NAVTEST  “test all available nav resources and report”
  NAV=5  “gps operable”
  IF(NAV=5) Go To CALCU5 (GPS) “recalculates using gps”
  IF(NAV=4) Go To CALCU4 (LOR) “recalculates using loran”
  IF(NAV=3) Go To CALCU3 (VOR) “recalculates using vor(s)”
  IF(NAV=2) Go To CALCU2 (INS) “recalculates using
inertial sys”
  IF(NAV=1) Go To CALCU1 (ADF) “recalculates using
adf(s)”
CALCU5
IF(NAV<5) Go To NAVTEST “recheck available nav equip and
report”
AVPOS4=(POS4+POS3+POS2+POS1)/4 “averaged pos of other navs”
(This represents a calculated reference for position sanity
check and may be optimized later)
IF(POS5−AVPOS4)>0.15(POS5) Go To CALCU5  “test pos5 for
validity”
  BKP=(NEXTLAT,NEXTLONG)  “updated position”
```

Yet another embodiment is to allow monitoring and reporting to be interfaced with systems within a vehicle. In this embodiment, the Communication and Navigation functions can be supplied by vehicle sub-systems. This requires Nav and Comm interface links which may already be in-place on existing equipment, but certified/authorized modifications must be made to the vehicle. This does not preclude the continued use of independent sub-systems as in the prior embodiment, but in addition allows for the interface with existing vehicle subsystems.

The monitoring, reporting and emergency authorized Control of vehicle systems, (fully integrated with the vehicle as a Vehicle Security and Control system), requires teaming and partnering of vehicle Original Equipment Manufacturers (OEM) to certify their vehicle with this overall Vehicle Security and Control System as part of their vehicle. The certification would include the system's ability to, if instructed by secure communication, to take control of the vehicle and either remain where it is, or drive to a known/preplanned secure location and shutdown vehicle power systems and continue reporting.

Considerations include the placement of the GPS and communication antennas, as well. The security system 10 may include the use of a switch or entry of data, including a PIN (personal identification number) if desired, into the CPU for activation. The activation could be automatic based upon no movement for a certain time period.

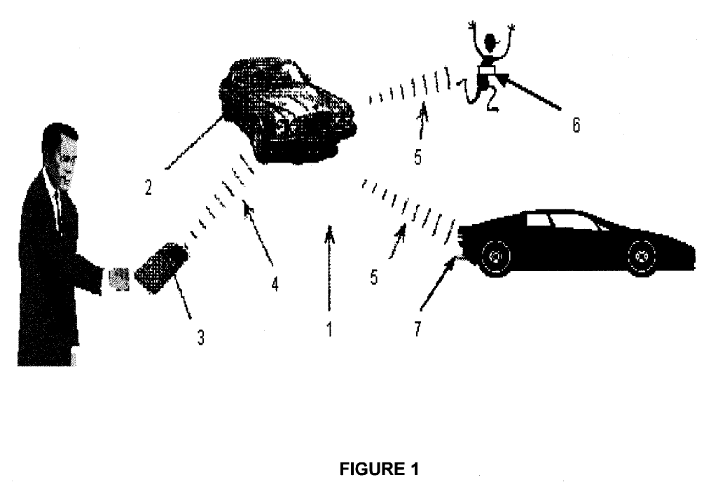

FIG. 1 illustrates the integrated system with a highly mobile device used by law enforcement agencies. In this embodiment, the automobile 1 is equipped with a GPS component with an on-board control unit and a communications component. The control unit activates the communications component to send an alert signal via satellite link, a cellular phone link and/or 2-way pager. Each of the communications servers can connect to the internet to provide PC based information.

The hardware components are conventional. The system can be powered by a 12 volt DC electrical harness. The electric power may be batteries or any other source mounted on the automobile or item to tracked.

The locator units may operate in different electronic positioning systems, such as GPS or LORAN. Each of these locator units may be mounted on a different item to be tracked on both may be the mounted on the same item. The security system may also use only a single positioning system. The locator units include, at least, an antenna and a receiver (not shown).

The activator could also be activated and deactivated by a telephone or computer. Once the system is activated and in the ARMED mode, the GPS receiver is ON and continually receives GPS updates. The updates may be spaced periodically to conserve electrical power. In these cases, a computer in the control unit stores the GPS data until the satellites are reacquired by the GPS.

When the activator is in the ARMED mode and the STAY mode is selected, the computer stores the geographical coordinates produced by the GPS. These coordinates are considered an authorized location. If a GPS update gives different geographical coordinates from those saved, while in the STAY mode, the control unit sends an ALERT message by the communications component. The ALERT message may be sent by any one or all of the communication systems. Obviously, the system may be equipped with only one of the communications links. The recipients of the ALERT message can be anyone or any office placed in the address list of the communications component, for example owners, operators, private security companies, dispatchers, or guards are among those who can be notified.

Once the ARMED mode is selected by the activator, the system may return to IDLE when a good position is acquired by the GPS. This position's coordinates are the same as stored when STAY command is entered in the system.

The system may be shut down or remain in STAY mode. In STAY mode, the GPS continually gets positions and compares them to stored positions, if the position is the same or within permitted parameters, the position is OK. If the location is different or outside limits, it has moved. The control unit issues an ALERT through the communications component.

Once the ALERT message is issued, the system gets positions continuously or periodically. New ALERTS are issued with new positions on a schedule.

Also, during the period when the STAY mode is selected but no ALERT has been issued, the system may be interrogated by any of the communications links. Upon interrogation the system will report its current coordinates and/or speed, direction, elevation. This information may be imposed an a map of any derivation. This is useful when a travel corridor is given as permissible coordinates but the exact location within the perimeter is not immediately known.

Further, in IDLE mode, any of the communications links may be used to interrogate the system to change to the ARMED mode, either on command, randomly or timed sequence. If no response is forthcoming a physical check should be implemented since a loss of electrical power or tampering is indicated.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A security system for establishing and monitoring the location of conveyances and reporting the movement thereof, comprising:
an activator component having multi-modes adapted to be mounted on a mobile conveyance and connected to a control unit, said activator producing a real time signal to said control unit, said control unit including a computer having a CPU with a memory and a geographical locator component for producing geographical coordinates of said real time signal of said activator component, said activator signaling said computer to read and store said geographical coordinates of said activator when said activator STAY mode is selected,
at least one RF tag sub-system for securement to an ancillary conveyance assigned to said mobile conveyance, said RF tag sub-system including a geographical locator component for producing geographical coordinates, said computer comparing said geographical coordinates of said mobile conveyance and said ancillary conveyance, said control unit connected to a communications component for automatically sending an alert when said real time signal of said activator of said ancillary conveyance is displaced from said stored STAY geographical coordinates.

2. The security system of claim 1 wherein said control unit interrogates said activator to produce said real time signal.

3. The security system of claim 1 further comprising a discrete electrical power source connected to said ancillary conveyance.

4. The security system of claim 1 wherein said activator includes an IDLE mode in which said activator produces no real time signal.

5. A security system of claim 1 further comprising said activator having a IDLE mode in which said communications component sends no alert.

6. The security system of claim 1 further comprising said system having a means for receiving an interrogation through said communications component to said geographical locator, said geographical locator giving current coordinates in response to said interrogation.

7. A security system for monitoring and reporting the movement of conveyance comprising:
a first conveyance equipped with an electrical system, radios and GPS for establishing, monitoring, and reporting the location thereof comprising an activator adapted to be interfaced with said GPS, a control unit including a computer connected to said activator and a communications component adapted to be interfaced with said radios, said control unit adapted to be connected to said GPS and said electrical system, said activator having a multiple position switch designating multi-modes, said multi-modes including a STAY mode in which said control unit supplies electrical power to said GPS and records said GPS generated geographical coordinates of said activator, said control unit interrogating said GPS periodically in real time and comparing said real time GPS generated geographical coordinates with the recorded GPS generated geographical coordinates; and at least one ancillary conveyance having an RF transmitter, said transmitter submitting GPS data periodically in real time and comparing said real time GPS generated geographical coordinates with the recorded GPS generated geographical coordinates, said control unit activating said communications component to send an alert by radio when said real time coordinates are different from said recorded coordinates.

8. The security system of claim 7 wherein said STAY mode includes a plurality of preselected geographical coordinates of a travel corridor, said control unit interrogating said conveyance mounted GPS periodically in real time and comparing said real time GPS generated coordinates with said plurality of preselected geographical coordinates and positions of said ancillary conveyances, said control unit activating said communications component to send an alert by radio when said real time coordinates are different from said plurality of said preselected coordinates.
